(19) United States
(12) Patent Application Publication
(10) Pub. No.: US 2003/0033423 A1
(43) Pub. Date: Feb. 13, 2003

(54) Wireless LAN system

(76) Inventors: Masafumi Okabe, Fukuoka (JP); Kazuhiro Muraoka, Fukuoka (JP); Hidetoshi Abeta, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/061,051

(22) Filed: Jan. 29, 2002

(30) Foreign Application Priority Data
Aug. 7, 2001 (JP) 2001-239779

(51) Int. Cl. G06F 15/16

(52) U.S. Cl. 709/232; 709/225

(57) ABSTRACT

In a wireless LAN system comprising a plurality of base stations and a mobile station, which transmits by wireless, from the base stations, a frame to which a source lower layer address specific to each of the base stations is assigned, the mobile station is provided with a filtering information storing unit for storing filtering information indicating whether or not the source lower layer address is a source lower layer address expected at the mobile station, and a frame filtering unit for selectively receiving the frame based on the filtering information.

### BACKGROUND OF THE INVENTION

1. Field of the Invention

The present invention relates to a wireless LAN system, and in particular to a wireless LAN system comprising a plurality of base stations and a mobile station (terminal) and transmitting frames from the base stations by wireless. The present invention also relates to a mobile station.

2. Description of the Related Art

In general, protocols on a LAN (Local Area Network) system are formed of layers such as a data link layer, a network layer, and a transport layer. When a mobile station receives a frame from a base station, the frame is processed at the lowest data link layer, and then processed at an upper layer if necessary.

A terminal in the prior art wired LAN system receives all of the frames on the LAN. The terminal refers to destination address information included in the frames at the data link layer, and passes a frame destined for its own MAC (Media Access Control) address (unicast frame), and a multicast or broadcast frame to the upper layer. Generally, a frame is passed to the upper layer without paying attention to a source address included in the frame of the data link layer.

On the other hand, in a wireless LAN system, a frame is received in the same reception method as the wired LAN system.

FIG. 14 shows a general arrangement of a wireless LAN system, which is composed of base stations 11-13 (occasionally, represented by a reference numeral “1”), a mobile station 2, a personal computer (hereafter, abbreviated as PC) 3, and a wired LAN 4 connecting the base stations 1 and the PC 3.

Furthermore, researches and developments are underway for a mobile IP to enable communications even if the terminal is moved. The mobile IP has been realized on various infrastructures such as a mobile network, a fixed network, and a wireless LAN system. FIG. 15 shows a general arrangement of a mobile IP using the wireless LAN system.

The base stations 11-13 are respectively provided with LAN i/f (interface) cards 11a-13a on the wired (fixed) side and LAN transceivers 11b-13b on the wireless side, and form routers 11c-13c inside.

The base stations 11-13 have specific MAC addresses mac 2-mac 4 and mac 5-mac 7 respectively on the wired side and the wireless side of the base stations 11-13, and manage a MAC address and an IP address of the subordinate mobile station 2.

When relaying a frame to the mobile station 2 or generating a frame to be transmitted, the base stations 1 assign their own MAC addresses mac 5-mac 7 on the wireless side to a source address region of a data link layer header of the frame to be transmitted.

The mobile station 2 has a fixed home base station, and directly transmits/receives a frame to/from the home station when the mobile station 2 is located in the area of the home station (within a reach of a radio wave).

In the mobile IP, a unicast frame is transmitted only from a base station (e.g. base station 12) in which the mobile station 2 has registered its location.

When the base station in which the mobile station 2 has registered its location is required to be changed as the mobile station 2 moves, the mobile station 2 registers the location of a new base station (e.g. base station 13). Also, the mobile station 2 sets a new address based on notified information from the base station, and sets the base station to a default gateway. Then, the mobile station 2 notifies, to the home base station, the information of the new base station in which the mobile station 2 has registered its location.

Hereafter, the unicast frame to the mobile station is received from the home base station through the base station in which the mobile station 2 has newly registered its location.

It is to be noted that the base station 1 has a source MAC address assigning unit and a base station information notifying unit. The source MAC address assigning unit assigns the MAC address of the base station to the source MAC address of the MAC header when the base station 1 relays the frame to the base station 2 to be transmitted. The base station information notifying unit transmits base station information including a base station ID to the wireless LAN network by broadcasting or multicasting.

Also, the mobile station 2 has a transmission quality measuring unit, an AP (Access Point) frame identifying unit, and a MAC address resolving unit. The transmission quality measuring unit measures the transmission qualities of all the base stations 1 which the mobile station 2 receives, so that the measured transmission qualities are used as indices for switching over the base stations 1 due to the movement.

The AP frame identifying unit identifies, from information included in the MAC header, a reception frame transmitted from the base station (access point) or one directly transmitted from other terminals. The MAC address resolving unit acquires the MAC address from the IP address.

As mentioned above, in the wireless LAN system, the mobile station has a state where it can receive radio waves from a plurality of base stations. In such a state, when a multicast frame or a broadcast frame is transmitted from a base station, the same frame reaches the mobile station in duplicate, so that all of the frames are passed to the upper layer. For this reason, the upper layer has to sift the same frame, thereby increasing a process load at the upper layer.

For solving this problem, there is proposed a technology of fixedly presetting a source address to be received in the receiving unit and of filtering at the data link layer, thereby reducing the process load at the upper layer (Japanese Patent Application Laid-open No. 5-336138).

However, such a conventional technology of fixedly setting the source base station for the reception can not be applied to the mobile station in which the source base station for the reception moves dynamically.

The multicast transmission is expected to be increasingly used in the field of convention type of service such as a telephone conference, a chat, and a game. For this reason, a duplex reception of the same frames as mentioned above can possibly occur frequently at the mobile station, so that the reduction of the load at this time is important.

### SUMMARY OF THE INVENTION

It is accordingly an object of the present invention to provide a wireless LAN system comprising a plurality of base stations and a mobile station, which transmits by wireless, from the base stations, a frame to which a source lower layer address specific to each of the base stations is assigned, enables a source base station address to be received to be dynamically changed, and decreases a process load of the mobile station.

Firstly, overall units on the side of the base station 1 will now be described.

The base station 1 is composed of a wired transceiver 21 connected to a wired LAN, a wireless transceiver 22 connected to a wireless LAN, and another processor 23. The wired transceiver 21 is provided with a wired reception unit 211 and a wired transmission unit 212, which has a source lower layer address assigning unit 2120.

The wireless transceiver 22 has a group base station managing unit 222, a wireless transmission unit 223, and a wireless reception unit 224 besides a unit 221 as the above-mentioned base station information notifying unit. The wireless transmission unit 223 is provided with the above-mentioned source lower layer address assigning unit 2230.

When the base station is a part of the wireless LAN network of a specified group composed of a plurality of base stations, the group base station managing unit 222 manages the lower layer addresses of the base stations in the same group, and sets the lower layer address information to the notified information transmitted to the mobile station by the base station information notifying unit 221.

The overall units on the side of the mobile station 2 will now be described.

The mobile station 2 has a wireless reception unit 31 and a wireless transmission unit 32 connected to the wireless LAN, the above-mentioned transmission quality measuring unit 33, a MAC processor 34, an IP processor 35, an upper protocol processor 36, and a unit 37 as the above-mentioned lower layer address resolving unit.

The MAC processor 34 is provided with an AP frame distributing unit 42, a filtering information generating unit 44, a filtering information storing unit 45, and a filtering information clearing unit 46 besides a unit 41 as the above-mentioned AP frame identifying unit.

Also, the filtering information generating unit 44 is provided with reception allowable base station-lower layer address information (table) 440 and a base station transmission quality managing table 441. The filtering information storing unit 45 is provided with filtering information 450, and the lower layer address resolving unit 37 is provided with default GW (gateway) information 370.

The frame filtering unit 43 compares the source lower layer address of the frame received from the AP frame distributing unit 42 with the filtering information 450 to determine whether or not the received frame should be passed to the IP processor 35.

The AP frame distributing unit 42 determines whether the frame received from the AP frame identifying unit 41 is transmitted from the base station 1 or directly transmitted from the other mobile station. According to the determined result, if the frame is directly transmitted from the base station 1, it is transmitted to the frame filtering unit 43, to which a filtering control is performed. If the frame is directly transmitted from the other mobile station, it is passed to the IP processor 35.

The filtering information storing unit 45 stores the filtering information (table) 450, and updates the filtering information 450 as necessary.

The filtering information generating unit 34 takes out a lower layer address from the notified information received from the wireless reception unit 31, prepares a list of receivable base stations, and provides the lower layer address whose transmission quality is optimum among the list to the filtering information storing unit 45 as the filtering information 450. However, after the reception allowable base station-lower layer address information 440 has already been set, the filtering information generating unit 34 does not set the base station except the base station having a lower layer address coincident with the information 440 in the filtering information 450.

The filtering information clearing unit 46 clears the filtering information 450, and enables the messages from all of the base stations 1 for the reception.

In order to achieve the above-mentioned object, the above-mentioned units compose the following present inventions respectively.

A mobile station in a wireless LAN system according to the present invention comprises: a filtering information storing unit for storing filtering information indicating whether or not the source lower layer address is a source lower layer address expected at the mobile station; and a frame filtering unit for selectively receiving the frame based on the filtering information (claim 1).

Namely, in the same way as the prior art, when relaying a frame to be transmitted to the mobile station 2, the source lower layer address assigning unit 2230 of the base station 1 assigns the lower layer address of its own base station to the source address of the frame to be transmitted. The mobile station 2 passes the received frame to the frame filtering unit 43.

The frame filtering unit 43 compares the source lower layer address of the received frame with the filtering information 450 held by the filtering information storing unit 45 in the mobile station 2. If they are coincident with each other, the received frame is passed to the IP processor 35 and the upper protocol processor 36. If they are not coincident with each other, the frame is discarded at the MAC processor 34. Thus, the frame filtering unit 43 selectively receives the frame.

Accordingly, unnecessary frames from base stations except reception allowable base stations are discarded at the lower layer, thereby reducing the process load of the whole mobile station.

Also, in the wireless LAN system according to the present invention, the above-mentioned mobile station may further comprise a filtering information generating unit for dynamically changing the filtering information according to a state of the mobile station (claim 2).

Namely, the filtering information generating unit 44 can update the filtering information 450 when the base station 1 for the reception is changed due to the movement of the mobile station 2.

Thus, by changing the filtering information 450 together with the move of the mobile station 2, the mobile station 2 can perform the frame filtering control.

Also, in the wireless LAN system according to the present invention, the above-mentioned base stations may be provided with a base station information notifying unit for notifying base station information including the source lower layer address specific to the base station, and the mobile station may be provided with a transmission quality measuring unit for measuring a transmission quality of each base station, and a filtering information generating unit for generating, based on a measured result of the transmission quality measuring unit, the filtering information having a source lower layer address of a frame received from a base station whose transmission quality is optimum and for providing the filtering information to the filtering information storing unit (claim 3).

Namely, the base station information notifying unit 221 of the base station 1 notifies the information of the base stations such as the lower layer address to the surroundings. When receiving the frame from the base station 1, the mobile station 2 measures a transmission (e.g. radio wave) quality of the source base station by the transmission quality measuring unit 33.

The filtering information generating unit 44 associates the source lower layer address of the notified information from the base station information notifying unit 221 with the transmission quality by the transmission quality managing table 441. The filtering information generating unit 44 generates the filtering information 450 in which the source lower layer address of the base station whose transmission quality is optimum is set to be received, and provides the filtering information 450 to the filtering information storing unit 45.

Thus, the dynamic change of the filtering information is made possible.

Also, the above-mentioned filtering information generating unit may preliminarily store receivable source lower layer addresses of a plurality of base stations as reception allowable base station-lower layer address information, and may select the source lower layer address of the frame received from the base station whose transmission quality within the transmission quality managing table 441 is optimum from the reception allowable base station-lower layer address information when the filtering information is generated (claim 4).

Namely, the filtering information generating unit 44 presets the list of the base station allowing the reception in the reception allowable base station-lower layer address information 440. This information 440 is manually set by using a maintenance command or the like in some cases, and is set by the notified information from the base station in other cases as follows.

Unless the source lower layer address of the base station designated by the filtering information generating unit 44 is set in the reception allowable base station-lower layer address information 440, the designated source lower layer address is not set in the filtering information 450 of the filtering information storing unit 45.

Thus, the reception from other base stations not allowed is limited.

Also, the above-mentioned base station may be provided with a group base station managing unit for managing the source lower layer address information of the base stations in a same group, the base station information notifying unit may set the source lower layer address of the group in its own notifying information to be transmitted, and the filtering information generating unit of the mobile station may generate the reception allowable base station-lower layer address information based on the source lower layer address of the same group included in the received notified information (claim 5).

Namely, when the concerned base station belongs to a specific group, the group base station managing unit 222 assigns the source lower layer address of the base station in the same group to the base station information notified by the base station information notifying unit 221.

The mobile station 2 receives the notified information, so that the filtering information generating unit 44 takes out the source lower layer address information of the base station in the same group from the notified information to generate the reception allowable base station-lower layer address information (table) 440.

Accordingly, as mentioned above, when the reception from the other base stations is limited, the reception allowable base station can be increased or decreased.

Also, the above-mentioned mobile station may be further provided with a lower layer address resolving unit for resolving a lower layer address of a gateway based on default gateway information of a destination base station preset, and the filtering information storing unit may change the filtering information based on the lower layer address of the default gateway information obtained by the lower layer address resolving unit (claim 6).

Namely, the default gateway information 370 is IP address information of the gateway necessary when the mobile station transmits the frame. The lower layer address resolving unit 37 leads a lower layer address of a terminal having the IP address from the IP address.

The lower layer address resolving unit 37 derives the lower layer address from the default gateway information 370, so that the lower layer address is set in the filtering information 450 of the filtering information storing unit 370.

Thus, it becomes possible to generate the filtering information 450 from the gateway information.

Also, the filtering information generating unit of the mobile station may add a source lower layer address of a base station whose transmission quality is optimum to the filtering information, and may delete a source lower layer address of a base station already set from the filtering information (claim 7).

Namely, when the base station for the reception is changed due to the movement of the mobile station, the filtering information generating unit 44 newly acquires the lower layer address of the base station capable of receiving. The address is assigned to the filtering information storing unit 45 to be added to the filtering information 450.

Thus, upon switchover of the base station, the frames from both of the source base station and the destination base station can be received. Hereafter, the filtering information storing unit 45 deletes the address information of the source base station from the filtering information 450, thereby enabling only the frame from the destination base station for the reception.

Also, when switching over a source base station based on the transmission quality, the above-mentioned mobile station may further be provided with a filtering information clearing unit for clearing the filtering information, and the filtering information generating unit may newly generate filtering information after switchover of a base station (claim 8).

Namely, when the base station for the reception is changed due to the movement of the mobile station, the filtering information clearing unit 46 clears the filtering information 450, so that the filtering information generating unit 44 newly sets the filtering information 450.

Thus, upon switchover of the base station, the frames from both of the source base station and the destination base station can be received. As a trigger of switching over the base stations, there is a case where the base station whose transmission quality is better than that of the base station communicating at the moment is detected by the transmission quality measuring unit 33.

Also, the above-mentioned filtering information generating unit may guarantee a time for receiving a frame from both base stations at least before and after the switchover during a shift from the filtering information before the switchover of the source base station to the filtering information after the switchover (claims 9 and 10).

Namely, the filtering information 450 is cleared during a movement of a base station as mentioned above, and a new address of a destination base station is added to the filtering information 450, thereby enabling frames from both of the source base station and the destination base station for the reception.

Then, after detecting that no frame is continuously transmitted from the source base station, or enough time that frames are no longer continuously transmitted from the source base station elapses, only the information from the destination base station is set in the filtering information 450.

Thus, when the frames waiting for the transmission are queued at the source base station upon switchover of a base station, a loss of a frame continuously transmitted from the source base station is avoided.

Also, the above-mentioned mobile station may further comprise an AP frame identifying unit for identifying, at a lower layer, a frame from another base station or a frame directly transmitted from the mobile station, and an AP frame distributing unit for providing only the frame received from the base station to the frame filtering unit (claim 11).

Namely, the AP frame identifying unit 41, in the same way as the prior art, identifies whether the frame is transmitted from the header information of the received frame by relaying the base station or the frame is directly transmitted from the other mobile station.

The frame identified by this AP frame identifying unit 41 passes through the AP frame distributing unit 41. If the received frame is directly transmitted from the other mobile station, it is passed to the IP processor 35. If it is transmitted by relaying the base station, it is passed to the frame filtering unit 33.

It is to be noted that a MAC address may be used as the above-mentioned lower layer address (claims 12 and 13).

### BRIEF DESCRIPTION OF THE DRAWINGS

FIG. 1 is a block diagram showing a schematic arrangement of a base station used in a wireless LAN system according to the present invention;

FIG. 2 is a block diagram showing a schematic arrangement of a mobile station used in a wireless LAN system according to the present invention;

FIG. 3 is a block diagram showing a hardware arrangement of a mobile station used in the present invention;

FIGS. 4A and 4B are diagrams showing an arrangement of a filtering information table used in the present invention;

FIG. 5 is a diagram showing an arrangement of a base station transmission quality managing table used in the present invention;

FIG. 6 is a diagram showing an arrangement of a reception allowable base station address table used in the present invention;

FIG. 7 is a diagram showing a general arrangement of a received frame;

FIG. 8 is a flow chart showing a filtering process example of a received frame in a mobile station according to the present invention;

FIG. 9 is a flow chart showing a reception process example of notified information in a mobile station according to the present invention;

FIG. 10 is a flow chart showing a setting process example of filtering information in a mobile station according to the present invention;

FIG. 11 is a flow chart showing an updating process example of Ad filtering information in a mobile station according to the present invention;

FIGS. 12A and 12B are diagrams illustrating a process load reduction effect by the present invention;

FIG. 13 is a diagram illustrating a memory reduction effect by the present invention;

FIG. 14 is a block diagram showing a reception state of the same frame in a general wireless LAN; and

FIG. 15 is a block diagram showing a general arrangement of a mobile IP.

Throughout the figures, like reference numerals indicate like or corresponding components.

### DESCRIPTION OF THE EMBODIMENTS

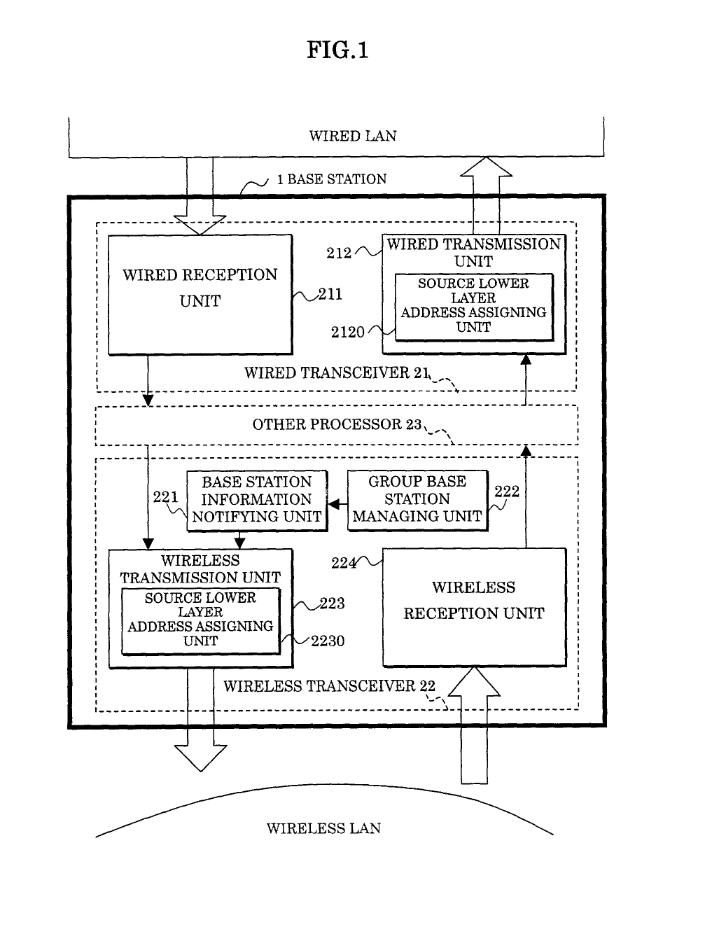

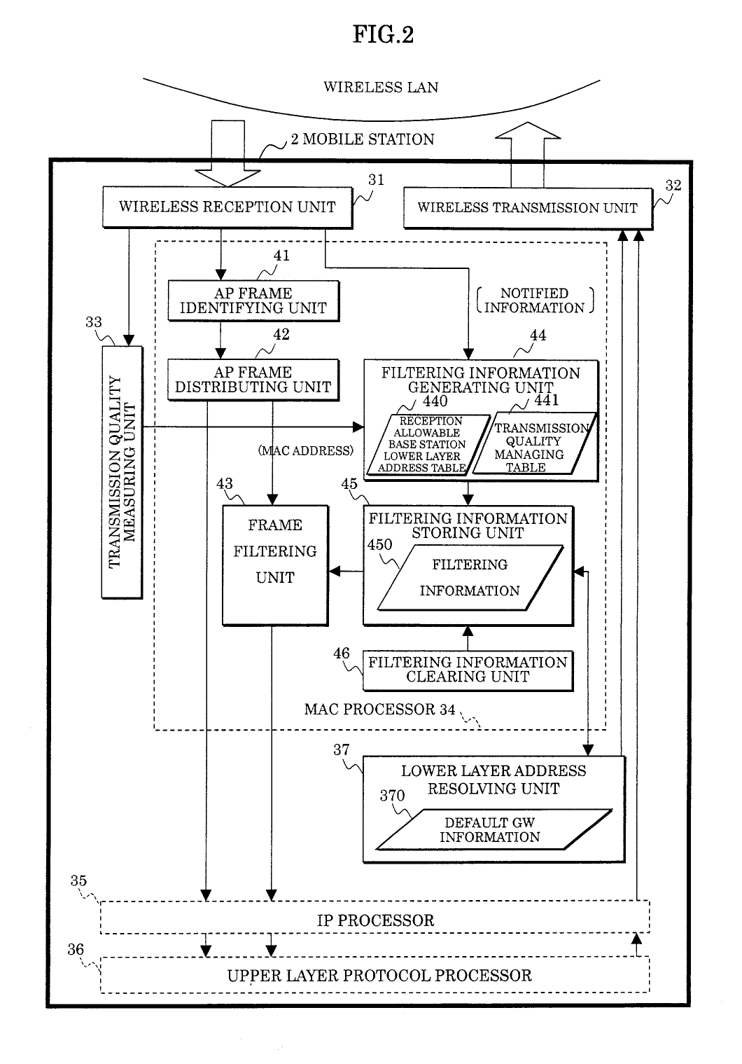

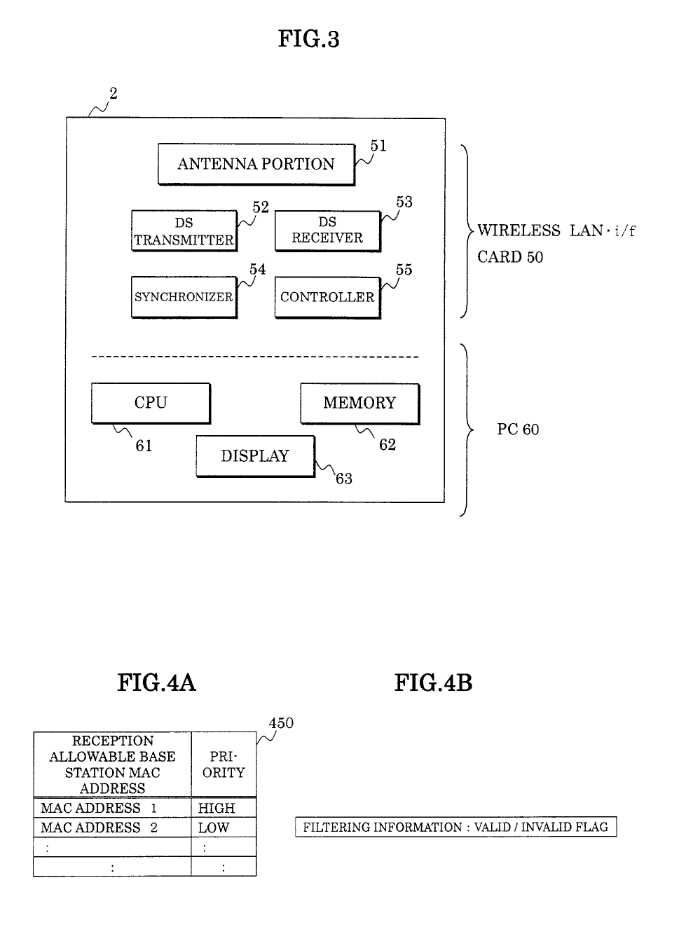

Hereinafter, the arrangement of the wireless LAN system according to the present invention schematically shown in FIGS. 1 and 2 will be described referring to FIGS. 3-11.

FIG. 3 shows a typical hardware arrangement in the mobile station 2. This hardware is composed of a wireless LAN i/f card 50 and a personal computer (PC) 60. The wireless LAN i/f card 50 is composed of an antenna portion 51, a DS transmitter 52, a DS receiver 53, a synchronizer 54, and a controller 55. The PC 60 is composed of a CPU 61, a memory 62, and a display 63. It is to be noted that the units of the present invention are mounted on the controller 55 in the wireless LAN i/f card 50.

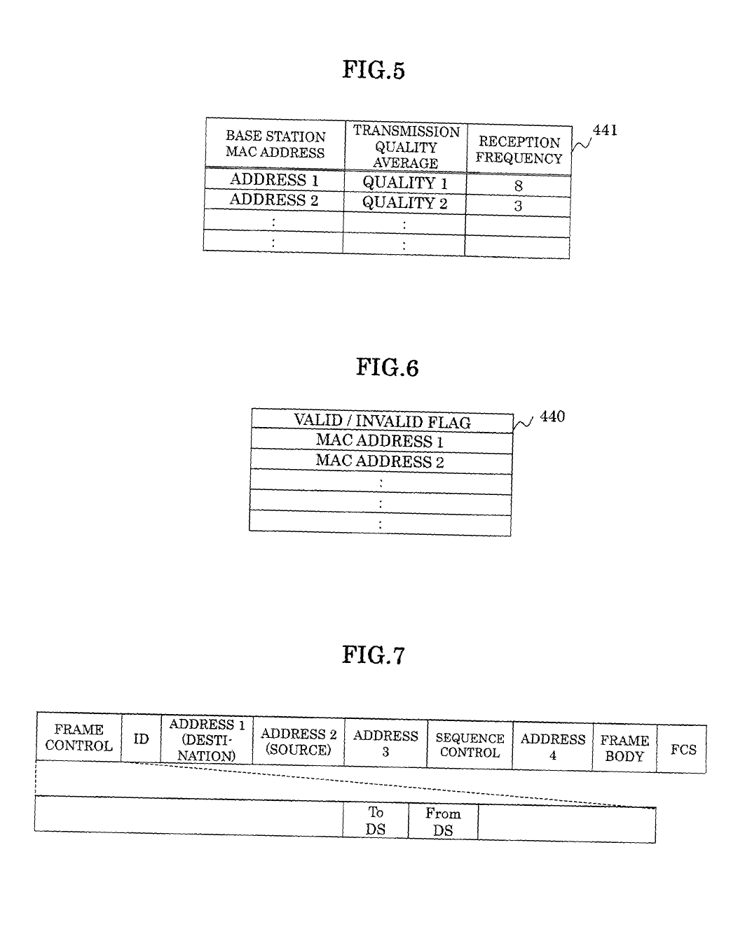

FIGS. 4A and 4B show an arrangement of a filtering information table 450. FIG. 5 shows an arrangement of a base station transmission quality managing table 441. FIG. 6 shows an arrangement of a reception allowable base station-MAC address table 440. FIG. 7 shows an arrangement of a received frame.

It is to be noted that while a MAC address is used as a lower layer address in this embodiment, the lower layer address is not limited to the MAC address.

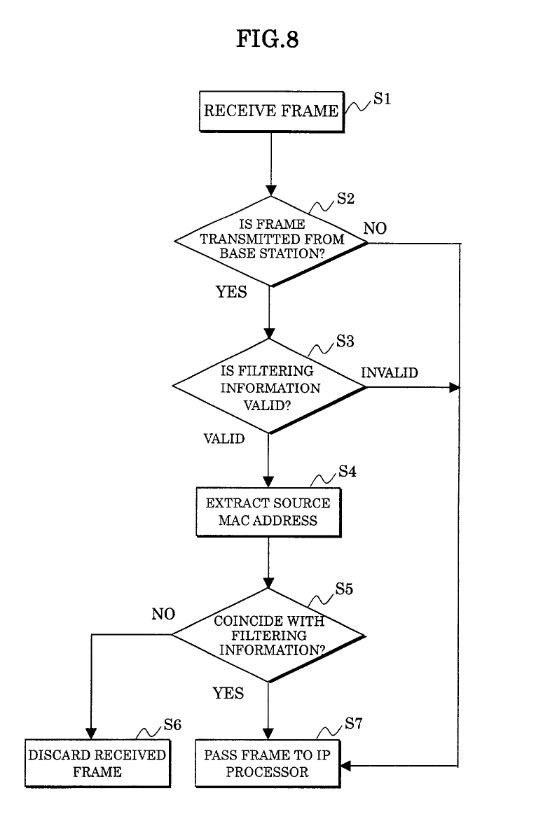

FIGS. 8-11 show operation embodiments of the wireless LAN system according to the present invention. Hereinafter, these operations will be sequentially described referring to FIGS. 1-7.

(1) The filtering information will be firstly described:

The filtering information 450 is a table of a MAC address of the base station 1 as shown in FIG. 4A. As for the MAC address table, two cases can be considered where the MAC address of the base station allowing the reception is set and the MAC address of the base station not allowing the reception is set. This embodiment will be described taking the case as an example where the MAC address allowing the reception is set for the filtering information 450.

While the base station allowing the reception is basically a single, a plurality of base stations are supposed to allow the reception in some cases. A priority is provided to the base station. When a plurality of base stations are set, a high priority is provided to a base station whose transmission quality is optimum, as shown in FIG. 4A. Also, there is another flag (see FIG. 4B) indicating a valid/invalid of the filtering information 450. When the flag is invalid, the filtering control is not performed.

(2) The filtering process flow of the received frame will now be described referring to FIG. 8:

When receiving a frame shown in FIG. 7 through the wireless reception unit 31 (at step S1), the mobile station 2 firstly determines whether or not the frame is transmitted from the base station 1.

The MAC header (Frame Control) of the received frame has, as shown in FIG. 7, “ToDS bit” and “FromDS bit” for determining whether the frame is relayed by the base station 1 to be transmitted, or the frame is transmitted from another mobile station. With these bits, the AP frame identifying unit 41 determines whether the frame is relayed by the base station 1 to be transmitted, or the frame is directly transmitted from the other mobile station (at step S2).

If it is a frame directly transmitted from the other mobile station, the AP frame distributing unit 42 passes the frame to the IP processor 35 without transmitting the same to the filtering unit 43 (at step S7).

If it is a frame transmitted from the base station 1, the frame filtering unit 43 refers to the valid/invalid flag (see FIG. 4B) of the filtering information 450 within the filtering information storing unit 45 (at step S3). If it is invalid, the frame is passed to the IP processor 35 (at step S7). If it is valid, the source MAC address is taken out (at step S4), and is compared with the filtering information 450 (at step S5).

If the same MAC address exists in the filtering information 450, the frame is passed to the IP processor 35 (at step S7), and otherwise is discarded at this point (at step S6).

(3) The setting of the filtering information will now be described:

There are following two main methods of setting the filtering information:

\mathring{1} Method using notified information

\mathring{2} Method using default gateway (GW) information

Hereinafter, the respective methods will be described.

\mathring{1} Filtering information setting method using notified information:

FIGS. 5 and 6 show data structures necessary for this method. FIG. 5 shows a base station transmission quality managing table 441 associating the MAC address list of the base station having received therefrom the notified information with the transmission quality of the base station as well as a notified information reception frequency. It is supposed that the average value according to the reception frequency is set to the transmission quality.

FIG. 6 shows an arrangement of a table 440 of the reception allowable base station-MAC address information. At the top of the table, the valid/invalid flag is set, which is manually set on the mobile station side. When the flag indicates invalid, it is a case where a specific group is not set, and the table is not referred to.

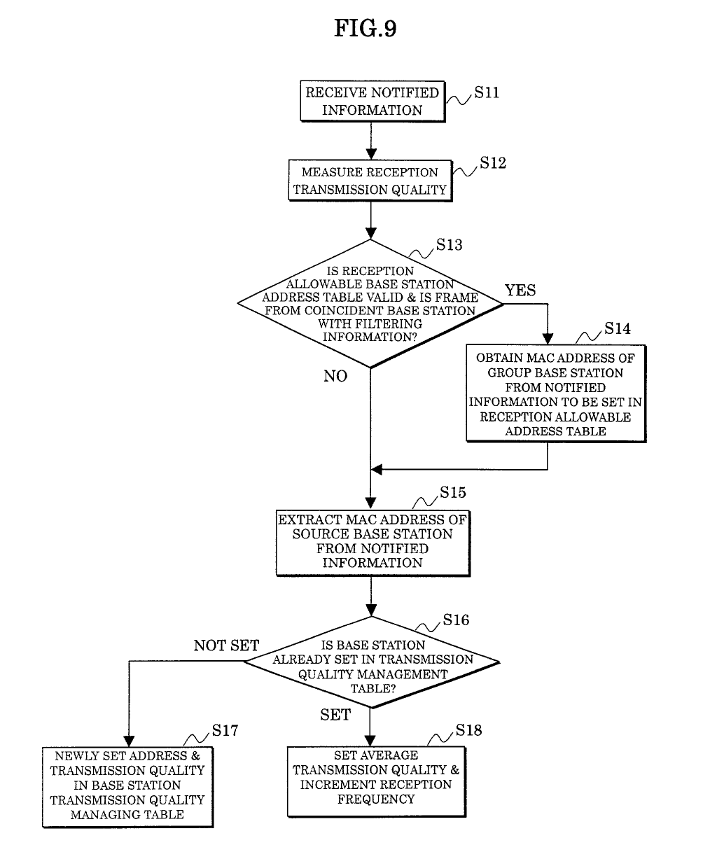

Hereinafter, the process upon reception of the notified information will be described referring to FIG. 9.

The “valid/invalid” of the reception allowable base station address table 440 and the initial value of the reception allowable base station address are preset in the mobile station 2 (see FIG. 6). Also, on the base station side, the base station information notifying unit 221 periodically broadcasts the notified information of the base station.

The notified information includes the list of the MAC addresses of its own base station and of base stations in the same group of its own base station managed by the group base station managing unit 222.

The mobile station 2 receives the notified information at the filtering information generating unit 44 through the wireless reception unit 31 (at step S11). The transmission quality measuring unit 33 measures the transmission quality upon reception of the information at the same time (at step S12).

In the mobile station 2, the filtering information generating unit 44 determines whether or not the flag of the reception allowable base station address table 440 shown in FIG. 6 is valid, and whether or not the received notified information is transmitted from the base station set in the reception allowable base station-MAC address table 440 shown in FIG. 6 (at step S13). If the result is “YES”, the group base station address list of the notified information is set collectively in the reception allowable address table shown in FIG. 6 (at step S14).

Then, the mobile station 2 takes out the MAC address of the source base station from the notified information (at step S15), and refers to the base station transmission quality managing table 441 shown in FIG. 5 (step S16).

As a result, if the MAC address is not set in the base station transmission quality managing table 441, the MAC address and the transmission quality at that time are set in the last of the table 440 (at step S17). If they are already set, the transmission quality and the reception frequency by the last reception are read out, the average of the transmission quality in view of the current transmission quality is set, and the reception frequency is added (at step S18).

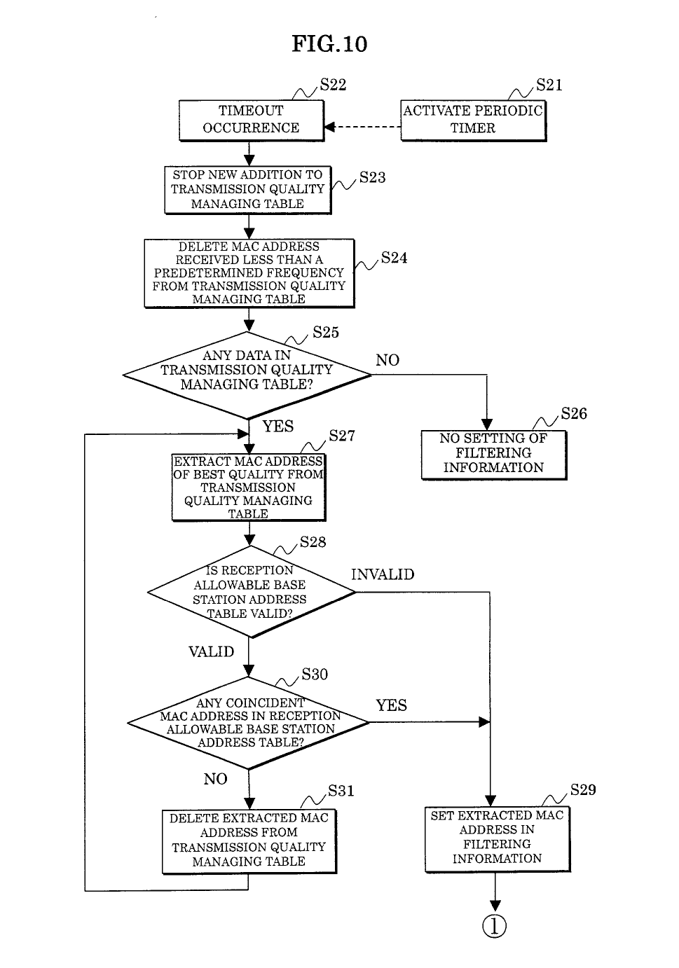

Hereinafter, the procedure of setting the filtering information 450 from the base station transmission quality managing table 441 shown in FIG. 5 will be described referring to FIG. 10.

Firstly, the mobile station 2 sets the filtering information 450 at fixed intervals by using a periodic timer (at step S21). When a timeout of the periodic timer occurs (at step S22), the filtering information generating unit 44 stops a new addition to the base station transmission quality managing table 441 upon reception of the notified information (at step S23).

Then, information received less than a predetermined frequency is deleted from the base station transmission quality managing table 441 (at step S24). This is because the notified information with less reception frequency, even with a good transmission quality, is regarded as having been received during the high-speed movement, thereby preventing the source base station of the notified information from being set in the filtering information 450.

The filtering information generating unit 44 confirms whether or not data exist in the base station transmission quality managing table 441 (at step S25). If the data do not exist, this means e.g. a radio wave failure, so that the filtering information 450 is not set (at step S26). If the data exist, the base station MAC address whose average transmission quality indicates an optimum value is taken out therefrom (at step S27).

The valid/invalid flag of the reception allowable base station address table 440 shown in FIG. 6 is read out (at step S28). If it is invalid, the source MAC address read out is unconditionally set in the filtering information 450 (at step S29). If the reception allowable base station address table 440 is valid, whether or not the source MAC address read out exists in the reception allowable base station address table 440 is retrieved (at step S30).

If there is found a coincident source MAC address, the source MAC address is set in the filtering information 450. If there is found no coincident source MAC address, the source MAC address is deleted from the base station transmission quality managing table 441 (at step S31), the process returns to step S27, and reads out the source MAC address indicating the optimum transmission quality. A series of operations are repeated, so that the filtering information 450 is determined.

\mathring{2} Filtering information setting method using default gateway information:

All of the base stations have a function corresponding to a router and mount thereon a function as a gateway. The mobile station in the wireless LAN stores the IP address of the base station, i.e. the default gateway in order to transmit frames. The mobile station acquires the MAC address by using an address resolving protocol (ARP) for the IP address of the default gateway. This MAC address may be set as filtering information 450.

(4) Update of the filtering information will be described:

A radio wave, from the base station 1, received by the mobile station 2 is not always constant, and the transmission quality thereof also varies as the mobile station 2 moves. When the transmission quality of the base station enabling the reception by the filtering control, deteriorates and the transmission quality of the other base station becomes better, it is required to change the filtering information 450.

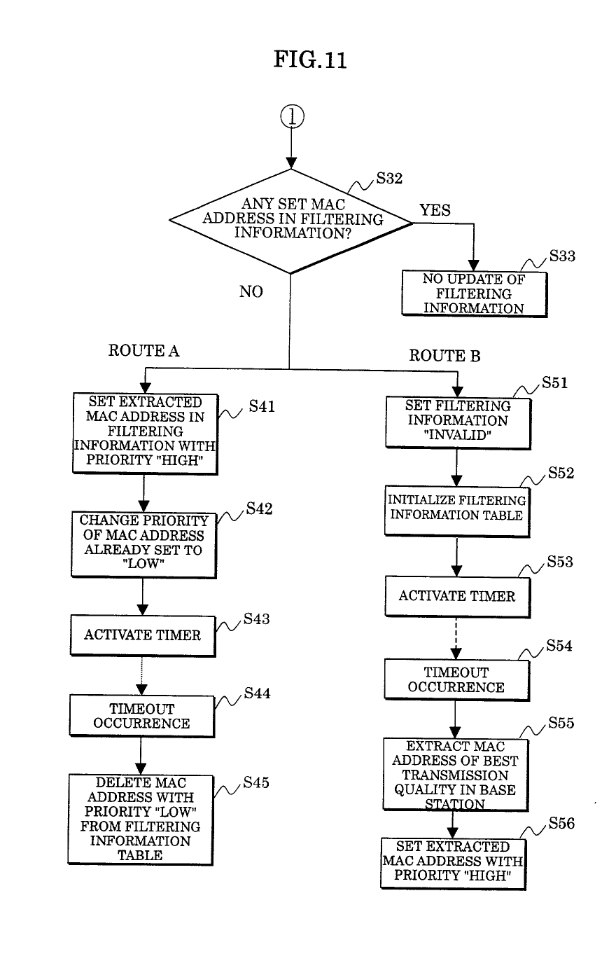

When the MAC address of the base station set by the filtering information setting method (at step S29) of the above-mentioned (3) exists in the filtering information (table) 450 shown in FIGS. 4A and 4B, the filtering information 450 is not updated as shown at steps S32 and S33 of FIG. 11. When the filtering information 450 does not exist, the filtering information generating unit 44 performs an updating process of the filtering information 450.

There are two filtering information updating methods as follows:

\mathring{1} New base station adding method

\mathring{2} Filtering information initializing method

A process flow upon updating the filtering information is shown at steps S41-S45 and steps S51-S56 of FIG. 11. A route “A” on the left side indicates the method \mathring{1}, and a route “B” on the right side indicates the method \mathring{2}. Either of the methods is preliminarily selected.

\mathring{2} New base station adding method (route “A”)

The filtering information generating unit 44 firstly sets the MAC address of the base station set by the filtering information setting method (at step S29) of the above-mentioned (3) in the filtering information 450 of the filtering information storing unit 45, and sets the priority of the address to “high” (at step S41). Then, the priority of the MAC address already set is changed to “low” (at step S42).

Hereafter, the filtering information generating unit 44 waits for a lapse of time enough to prevent frames queued at the source base station from failing in reception. For waiting for the lapse of time, there are two methods of waiting for a timeout after having activated a timer of a sufficient time (at steps S43 and S44) and of detecting the fact that any frame is no longer transmitted from the source base station.

After a lapse of a fixed time, the MAC address whose priority is set to “low” in the filtering information table 450 is deleted (at step S45), and only the source MAC address of the base station newly added is left in the filtering information.

\mathring{2} Filtering information initializing method (route “B”)

The valid/invalid flag of the filtering information is firstly set to “invalid” (at step S51), so that a state where frames from all of the base stations can be received is brought about.

Then, the filtering information table 450 is initialized (at step S52) to clear the MAC address set.

Hereafter, the filtering information generating unit 44 waits for a lapses of time enough to prevent frames queued at the source base station from failing in reception in the same way as the method \mathring{1} (at steps S53 and S54).

After a lapse of a fixed time, the MAC address of a new base station whose transmission quality is optimum is extracted by using the above-mentioned filtering information setting method (at step S55), the extracted MAC address is set in the filtering information 450 with the priority “high” (at step S56), and the valid/invalid flag of the filtering information is set to be valid.

As described above, a wireless LAN system according to the present invention is arranged such that a mobile station is provided with a filtering information storing unit for storing filtering information indicating whether or not a source lower layer address is a source lower layer address expected at the mobile station, and a frame filtering unit for selectively receiving the frame based on the filtering information. Therefore, when the mobile station receives frames from a plurality of base stations, filtering at a lower layer can be performed, and a process load of a whole mobile station can be reduced. The present invention is especially effective for a multicast.

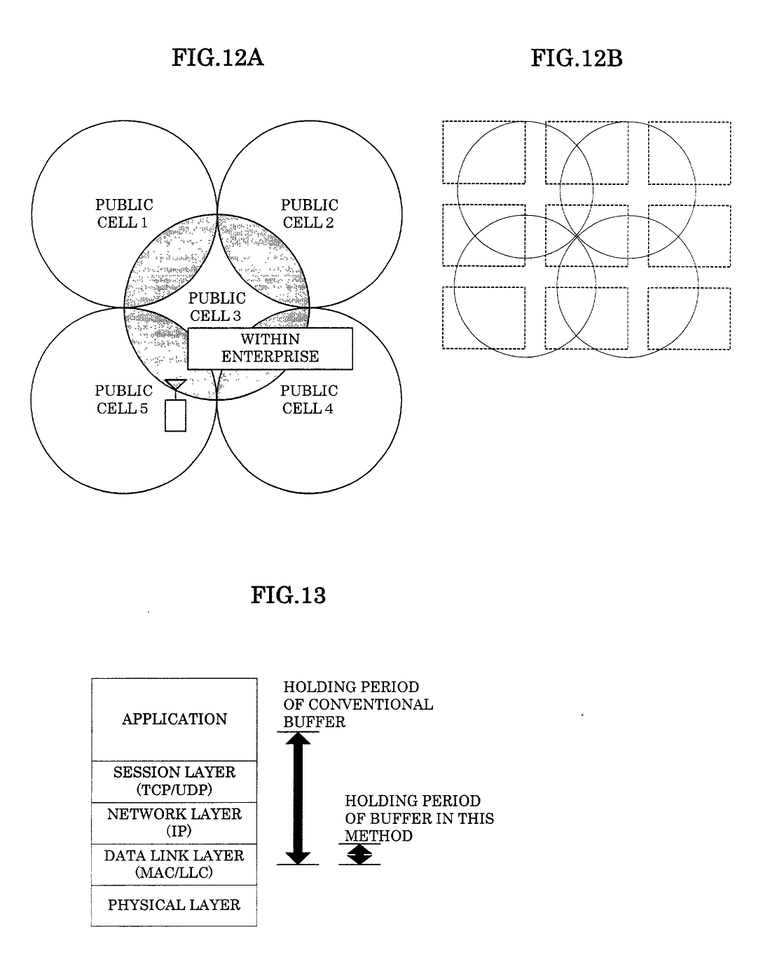

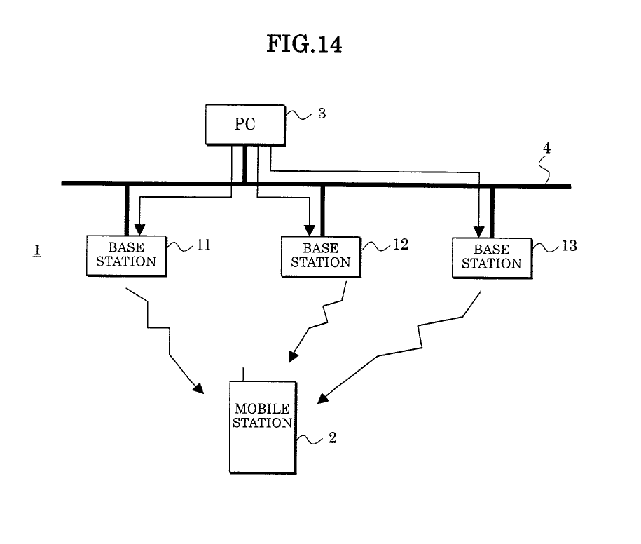

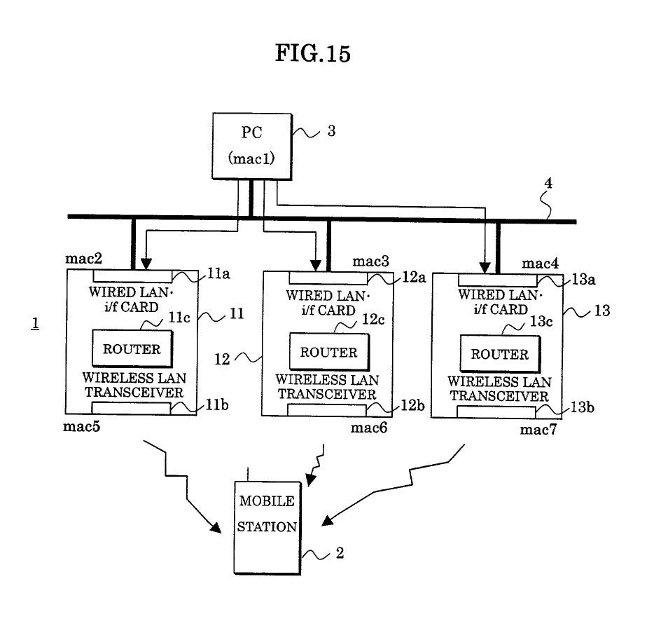

In the present invention, the effect in the case where a mobile terminal receives the same frame from a plurality of base stations is achieved in the case where the mobile station moves to a zone where public cells overlap. The ratio of the overlap between the public cells depends on a cell arrangement. However, as shown in FIG. 12A, an equilateral hexagon, an equilateral quadrangle, and an equilateral triangle are generally basic patterns. Also, as shown in FIG. 12B, considering buildings and intersections in urban areas, overlapping portions between zones increase according to the number of mobile terminals and the status of obstacles.

In FIG. 12A, the ratio of the public cell C3 to the portion (hatched portion) where a public cell C3 overlaps with other public cells C1, C2, C4, and C5 assumes almost 7 to 5 based on the following calculation, if the ratio of the circumference of a circle to its diameter is assumed to be 3.14:

Area of unit cell=π R²=3.14 R², and

Overlap area=(2 π−4)R²=2.28 R², where they are calculated from ¼ of a single circle area=right isosceles triangle area of R+half of overlapped area.

Area of unit cell: overlapped area=3.14 R² :2.28 R²=157:114 ≈7:5

It is seen that under these circumstances, the present invention is effective in the area of 5/7.

Considering such a status, specific effects of the present invention are as follows:

(1) Reduction of received packet number

As for the packets received by the mobile terminal, there are a unicast packet and a multicast packet. In the present status of the mobile phone, the unicast is transmitted/received for one or two hours at most in a day, and is not always transmitted/received. The multicast is supposed to be always distributed for characteristics of service.

A single packet can be transmitted from each base station at the same time, and a plurality of packets can not be transmitted at the same time. However, the unicast and the multicast are supposed to be transmitted at the same time by calculation.

The received packet amount in a day at the mobile station is

Unicast+multicast+notified information and the like, this being too little to be considered.

When the present invention is not applied, the received packet amount in a day at the mobile station is:

Unicast for one hour+24 hours×multicast for two base stations×(1+5/7).

When the present invention is applied, the received packet amount in a day at the mobile station is:

Unicast for one hour+24 hours×multicast for two base stations×(1).

The ratio of the received packet number per day when the present invention is applied to the received packet number per day when the present invention is not applied is as follows, assuming that the packet number of the unicast per unit time is the same as that of the multicast, enabling the received packet number to be reduced by 40% (the packet number per unit time is assumed to be “P”):

When the present invention is adopted: P+24×P×(1)=25 P,

When the present invention is not adopted: P+24×P×(1+5/7) ≈42 P, and

When the present invention is adopted: When the present invention is not adopted=25:42.

Also, when an enterprise network resides within the public network, the mobile terminal having this function used only within the enterprise network can avoid receiving the multicast packet distributed by the public network, although the unicast packet amount increases.

If an available time by a unicast is supposed to be 8 hours, the followings can be obtained, enabling 84% of the received packet number to be reduced:

When the unicast is used in the enterprise:unicast for 8 hours+=8P, and

When the present invention is adopted: when the present invention is not adopted=8:49.

(2) Reduction of available memory amount

The reduction ratio of the received packet according to the present invention is as mentioned above. With this reduction, the memory amount used as a receiving buffer of the packet is also reduced.

The identification of the same packet has been performed by an application so far. Therefore, the holding time of the receiving buffer is lengthy, and a packet loss due to a buffer shortage arises upon reception of a large amount of packets.

However, if the present invention is adopted, unnecessary packets are discarded at a data link layer, thereby enabling a packet loss due to a buffer shortage to be reduced compared with the prior art.

When the ratio of the buffer holding time until the layers and the application shown in FIG. 13 identify the same packet is supposed to MAC/LLC:IP:TCP:application=1:3:5:5 where since IP layer, TCP layer, and application layer have many checking items, the holding time is long, the following effect can be achieved by adopting the present invention in the public network:

When the present invention is adopted; Packet discarded at data link layer×time ratio (1)+packet notified to application×time ratio (14)=(42-25)×1+25+14=367.

When the present invention is not adopted; Packet notified to the application×time ratio (14)=42×14=588 Accordingly, the ratio of the buffer holding time is as follows: When the present invention is adopted: when the present invention is not adopted=367:588.

Therefore, the holding time becomes 62% of the case where the present invention is not adopted, and a memory can effectively utilized.

Also, there is a process of notifying to the application beside the reception buffer, and a process of queuing or the like at the application, resulting in a more effect of memory reduction.

Thus, as more and more mobile terminals are IPized hereafter, simultaneous distribution type service, etc. of games and information using multicast is expected to increase, so that the load reducing effect by the present invention is much more enhanced.

Furthermore, the load reducing effect by the present invention leads to a secondary effect as follows:

Improvement of a communication response due to a CPU load reduction, in addition, improvement of user operability,

Extensive reduction of frames passed to the upper layer, and saving of buffer amount between CPU and LAN chips due to a CPU load reduction,

Reduction of memory and downsizing of terminal by saving the buffer amount,

Reduction ratio of frames discarded by a buffer overflow of a handling buffer between CPU and LAN chips,

Improvement of a battery longevity at a mobile station due to the reduction of CPU operation rate, and

Wireless LAN terminal mountability of a low cost CPU with a low processing performance

Furthermore, in a circumstance where a plurality of wireless LAN networks such as an enterprise wireless LAN network and a public wireless LAN network for different applications exist together, it becomes possible for a terminal to avoid a process load increase by a frame reception from a wireless LAN with which a mobile station does not communicate.

What we claim is:

1. A mobile station in a wireless LAN system transmitting by wireless, from a plurality of base stations, a frame to which a source lower layer address specific to each of the base stations is assigned comprising:
a filtering information storing unit for storing filtering information indicating whether or not the source lower layer address is a source lower layer address expected at the mobile station; and
a frame filtering unit for selectively receiving the frame based on the filtering information.

2. The mobile station as claimed in claim 1, further comprising a filtering information generating unit for dynamically changing the filtering information according to a state of the mobile station.

3. A wireless LAN system comprising:
a plurality of base stations; and
a mobile station,
each of the base stations transmitting therefrom by wireless a frame to which a source lower layer address specific to each of the base stations is assigned, and being provided with a base station information notifying unit for notifying base station information including the source lower layer address specific to the base station, and
the mobile station being provided with a transmission quality measuring unit for measuring a transmission quality of each base station, a filtering information storing unit for storing filtering information indicating whether or not the source lower layer address is a source lower layer address expected at the mobile station, a frame filtering unit for selectively receiving the frame based on the filtering information, and a filtering information generating unit for generating, based on a measured result of the transmission quality measuring unit, the filtering information having a source lower layer address of a frame received from a base station whose transmission quality is optimum and for providing the filtering information to the filtering information storing unit.

4. The wireless LAN system as claimed in claim 3 wherein the filtering information generating unit preliminarily stores receivable source lower layer addresses of a plurality of base stations as reception allowable base station-lower layer address information, and selects the source lower layer address of the frame received from the base station whose transmission quality is optimum from the reception allowable base station-lower layer address information when the filtering information is generated.

5. The wireless LAN system as claimed in claim 4 wherein the base station is provided with a group base station managing unit for managing the source lower layer address information of the base stations in a same group, and the base station information notifying unit sets the source lower layer address of the group in its own notifying information to be transmitted, and
the filtering information generating unit of the mobile station generates the reception allowable base station-lower layer address information based on the source lower layer address of the same group included in the received notified information.

6. The wireless LAN system as claimed in claim 3 wherein the mobile station is further provided with a lower layer address resolving unit for resolving a lower layer address of a gateway based on default gateway information of a destination base station preset, and the filtering information storing unit changes the filtering information based on the lower layer address of the default gateway information obtained by the lower layer address resolving unit.

7. The wireless LAN system as claimed in claim 3 wherein when switching over a source base station based on the transmission quality, the filtering information generating unit of the mobile station adds a source lower layer address of a base station whose transmission quality is optimum to the filtering information, and deletes a source lower layer address of a base station already set from the filtering information.

8. The wireless LAN system as claimed in claim 3 wherein when switching over a source base station based on the transmission quality, the mobile station is further provided with a filtering information clearing unit for clearing the filtering information, and the filtering information generating unit newly generates filtering information after switchover of a base station.

9 The wireless LAN system as claimed in claim 7 wherein during a shift from the filtering information before the switchover of the source base station to the filtering information after the switchover, the filtering information generating unit guarantees a time for receiving a frame from both base stations at least before and after the switchover.

10 The wireless LAN system as claimed in claim 8 wherein during a shift from the filtering information before the switchover of the source base station to the filtering information after the switchover, the filtering information generating unit guarantees a time for receiving a frame from both base stations at least before and after the switchover.

11. The wireless LAN system as claimed in claim 3 wherein the mobile station further comprises an AP frame identifying unit for identifying, at a lower layer, a frame from another base station or a frame directly transmitted from the mobile station, and an AP frame distributing unit for providing only the frame received from the base station to the frame filtering unit.

12. The wireless LAN system as claimed in claim 1 wherein the lower layer address comprises a MAC address.

13. The wireless LAN system as claimed in claim 3 wherein the lower layer address comprises a MAC address.
